(19) United States
(12) Patent Application Publication
(10) Pub. No.: US 2025/0219985 A1
(43) Pub. Date: Jul. 3, 2025

(54) ELECTRONIC DEVICE AND METHOD FOR IDENTIFYING USER MATCHED TO EXTERNAL ELECTRONIC DEVICE ON BASIS OF LOG INFORMATION

(71) Applicant: NCSOFT Corporation, Seoul (KR)

(72) Inventors: Jaeik CHO, Seongnam-si (KR); Namjun KIM, Seongnam-si (KR); Jongsoo KIM, Seongnam-si (KR); Gyutae BAN, Seongnam-si (KR); Gyuho LEE, Seongnam-si (KR)

(73) Assignee: NCSOFT Corporation, Seoul (KR)

(21) Appl. No.: 19/086,528

(22) Filed: Mar. 21, 2025

Related U.S. Application Data
(63) Continuation of application No. PCT/KR2022/021422, filed on Dec. 27, 2022.

(51) Int. Cl. H04L 61/09

(52) U.S. Cl. CPC H04L 61/09

(57) ABSTRACT

An electronic device may be provided. The electronic device may, obtain, from a plurality of first external electronic devices executing an agent program, log information associated with one or more second external electronic devices accessing each of the plurality of first external electronic devices, wherein the log information comprises first IP addresses associated with the plurality of first external electronic devices and second IP addresses associated with the one or more second external electronic devices; determine a mapping of respective first external electronic devices with the one or more second external electronic devices that accessed the respective first external electronic devices based on a grouping of the log information; and obtain, based on the grouping of the log information and user information indicating users associated with the second IP addresses, management information of at least one user associated with the respective first electronic devices.

### CROSS-REFERENCES TO RELATED APPLICATIONS

This application is a continuation of International Application No. PCT/KR2022/021422, filed on Dec. 27, 2022, with the Korean Intellectual Property Office, the disclosure of which is incorporated by reference herein in its entirety.

### BACKGROUND

### 1. Technical Field

The present disclosure relates to an electronic device and a method for identifying a user matched to an external electronic device based on log information.

### 2. Related Art

An electronic device may transmit information to external electronic devices or receive information from external electronic devices. The electronic device may generate a database based on information received from the external electronic devices. However, methods and systems for classifying user information and issue information transmitted from external electronic devices to correspond to each of users is required.

### SUMMARY

According to an embodiment, an electronic device may comprise communication circuitry and one or more processors. The processors may, using the communication circuitry, using the communication circuitry, obtain, from a plurality of first external electronic devices executing an agent program, log information associated with one or more second external electronic devices accessing each of the plurality of first external electronic devices, wherein the log information comprises first IP addresses associated with the plurality of first external electronic devices and second IP addresses associated with the one or more second external electronic devices; determine a mapping of respective first external electronic devices with the one or more second external electronic devices that accessed the respective first external electronic devices based on a grouping of the log information obtained from the plurality of first external electronic devices based on the second IP addresses associated with the one or more second external electronic devices; obtain, based on the grouping of the log information and user information indicating users associated with the second IP addresses, management information of at least one user associated with the respective first electronic devices; identify an external electronic device different from the plurality of first external electronic devices; and transmit, to the external electronic device, display information for displaying a user interface, the display information comprising issue information associated with a first external electronic device among the plurality of first external electronic devices and a visual object for notifying the issue information.

According to an embodiment, a method performed by an electronic device may comprise, using communication circuitry, obtaining, from a plurality of first external electronic devices executing an agent program, log information associated with one or more second external electronic devices accessing each of the plurality of first external electronic devices, wherein the log information comprises first IP addresses associated with the plurality of first external electronic devices and second IP addresses associated with the one or more second external electronic devices; determining a mapping of respective first external electronic devices with the one or more second external electronic devices that accessed the respective first external electronic devices based on a grouping of the log information obtained from the plurality of first external electronic devices based on the second IP addresses associated with the one or more second external electronic devices; obtaining, based on the grouping of the log information and user information indicating users associated with the second IP addresses, management information of at least one user associated with the respective first electronic devices; identifying an external electronic device different from the plurality of first external electronic devices; and transmitting, to the external electronic device, display information for displaying a user interface, the display information comprising issue information associated with a first external electronic device among the plurality of first external electronic devices and a visual object for notifying the issue information.

According to an embodiment, the electronic device may comprise memory, communication circuitry, and one or more processors. The one or more processors may identify, based on identifying an external electronic device different from a plurality of first external electronic devices executing an agent program using the communication circuitry, a user logged in the external electronic device; transmit, based on management information, first information to display a screen including IP addresses associated with the user logged in the external electronic device and a list of the one or more first external electronic devices associated with each of the IP addresses, to the external electronic device; and transmit, based on receiving a signal indicating selection of a first external electronic device in the list of the one or more first external electronic devices from the external electronic device, second information with respect to the first external electronic device selected in the list, to the external electronic device.

An electronic device, a method thereof, and a non-transitory computer-readable storage medium according to various embodiments can provide information received from external electronic devices to a user. The electronic device can classify and provide the information to correspond to each user.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF DRAWINGS

The present disclosure will be easily understood from the following description taken in conjunction with the accompanying drawings in which reference numerals denote structural elements.

FIG. 1 illustrates an example of an electronic device and external electronic devices according to an embodiment.

FIG. 2 illustrates an example of a signal flow chart between an electronic device and external electronic devices according to an embodiment.

FIG. 3A illustrates an exemplary log information received from an external electronic device according to an embodiment.

FIG. 3B illustrates an exemplary grouping of log information and IP addresses of an external electronic device according to an embodiment.

FIG. 3C illustrates exemplary management information according to an embodiment.

FIG. 4 illustrates an example of a user interface displayed based on management information, according to an embodiment.

FIG. 5 illustrates an exemplary with respect to an operation of an electronic device according to an embodiment.

FIG. 6 illustrates an exemplary flowchart with respect to an operation of an electronic device according to an embodiment.

### DETAILED DISCLOSURE

Hereinafter, various embodiments of the present document will be described with reference to the accompanying drawings.

It should be appreciated that various embodiments of the present disclosure and the terms used therein are not intended to limit the technology set forth herein to particular embodiments and include various changes, equivalents, or replacements for a corresponding embodiment. With regard to the description of the drawings, similar reference numerals may be used to refer to similar elements. A singular expression may include a plural expression unless context clearly indicates otherwise. In the present document, an expression such as “A or B”, “at least one of A and/or B”, “A, B or C”, or “at least one of A, B and/or C”, and the like, may include all possible combination of items arranged together. Expressions such as “1st ”, “2nd”, “first”, or “second”, and the like, may modify the corresponding components regardless of order or importance, and are only used to distinguish a component from another component, but do not limit the components. When a (e.g., first) component is mentioned as “(functionally or communicatively) coupled” or “connected” to another (e.g., second) component, the component may be connected directly to the other component, or may be connected through another component (e.g., third component).

As used in the present document, the term “module” may include a unit configured with hardware, software, or firmware, and may interchangeably be used with other terms, for example, “logic,” “logic block,” “part,” or “circuitry”. A module may be a single integral component, or a minimum unit or part thereof, adapted to perform one or more functions. For example, the module may be configured with an application-specific integrated circuit (ASIC).

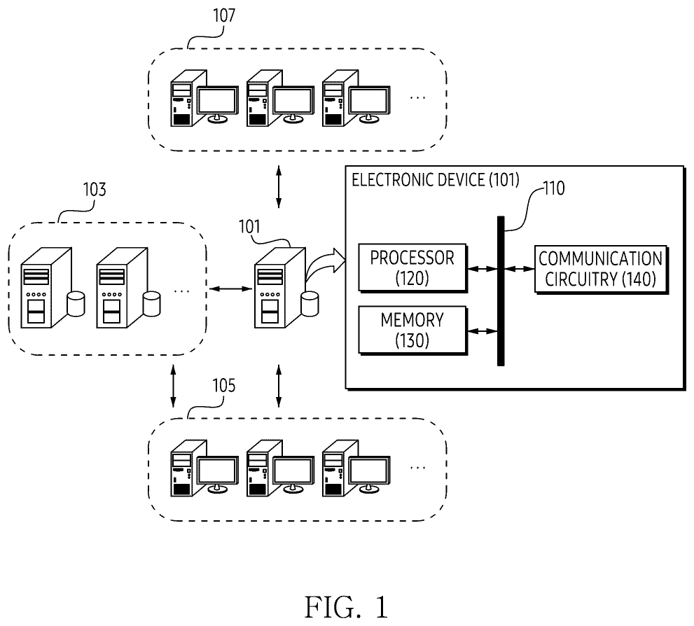

FIG. 1 illustrates an example of an electronic device and external electronic devices according to an embodiment.

Referring to FIG. 1, according to an embodiment, an electronic device 101 may be connected to external electronic devices 103, 105, and 107 through communication circuitry. For example, the electronic device 101 may be connected wirelessly and/or wiredly to the external electronic devices 103, 105, and 107 in a network environment. For example, the electronic device 101 may establish a communication link with the external electronic devices 103, 105, and 107 through the communication circuitry. The electronic device 101 may receive information and/or a signal from the external electronic devices 103, 105, and 107, or transmit the information and/or the signal to the external electronic devices 103, 105, and 107, based on establishing the communication link.

In embodiments, the electronic device 101 may be referred to as a master device and/or a master server. In embodiments, a first external electronic devices 103 may be referred to as a slave server and/or a slave device. In embodiments, a second external electronic devices 105 may be a terminal owned by a user. In embodiments, a third external electronic devices 107 may be a terminal owned by a user. The terminal may include a smartphone, a smart pad, and/or a personal computer (PC). Hereinafter, operations in which the electronic device 101 generates a database using information (or data) transmitted from the first external electronic devices 103, the second external electronic devices 105, and/or the third external electronic devices 107 will be described.

According to an embodiment, the electronic device 101 may receive log information generated when a second external electronic device accesses a first external electronic device. For example, the first external electronic device may be an external electronic device executing an agent program. The agent program may be a program for collecting information associated with the second external electronic devices different from the first external electronic device connected to the first external electronic device. In embodiments, log information may include binary information. For example, the binary information may include information encoded in a binary format to be stored as a computer file such as a ‘non-text file’. According to an embodiment, the electronic device 101 may receive the generated log information from the second external electronic devices 105 when the second external electronic devices 105 access the first external electronic devices 103.

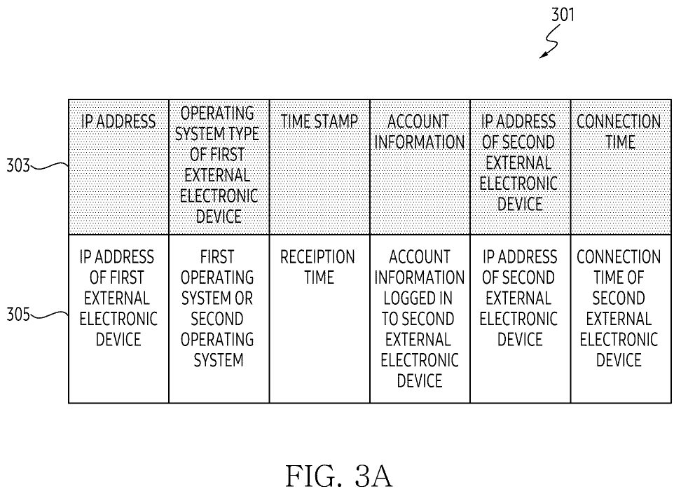

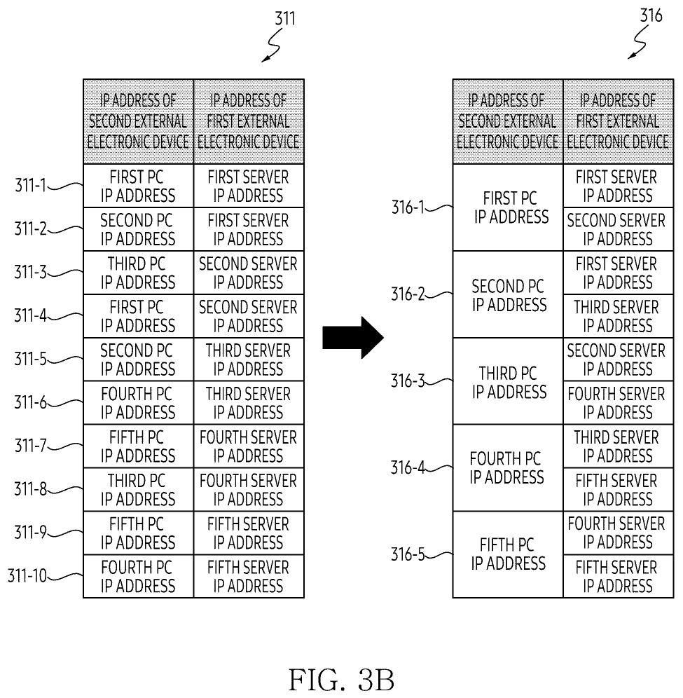

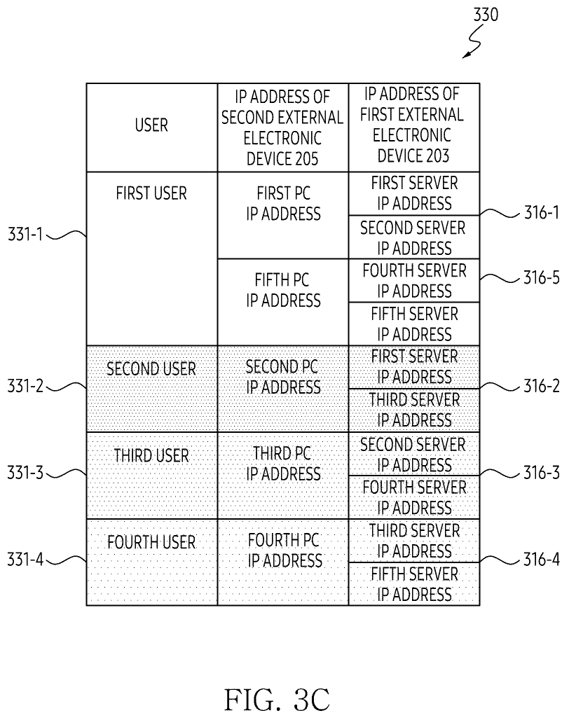

According to an embodiment, the electronic device 101 may change the log information, which is first log information including the binary information, into second log information including character string information, based on receiving the first log information. For example, the second log information may include characters readable by human. According to an embodiment, the electronic device 101 may generate a database associated with the second log information, based on obtaining the second log information from the first log information. For example, the database may include timing at which the second external electronic device is connected to the first external electronic device. The database may include an IP address of the first external electronic device. The database may include information associated with an account used when the second external electronic device accesses the first external electronic device. The database may include a time period in which the second external electronic device is connected to the first external electronic device. The database may include information associated with a type of an operating system of the second external electronic device. The electronic device 101 may store the database in memory 130, based on generating the database including the second log information. A description associated with the log information is described later in FIG. 3A.

According to an embodiment, the electronic device 101 may group the first log information and/or the second log information, obtained from a plurality of first external electronic devices 103. The grouping may be based on internet protocol (IP) addresses of the second external electronic devices 105. For example, the first log information may include the binary information and the second log information may include the character string information. In embodiments, the electronic device 101 may perform a join operation on the log information obtained from the plurality of first external electronic devices 103. The join operation may be performed based on a table of a database obtained based on the log information. For example, the join operation may be performed based on a common type in the table. For example, the electronic device 101 may perform the join operation based on the IP addresses of the second external electronic devices 105 in the log information. The electronic device 101 may group the log information based on the IP addresses of each of the second external electronic devices 105. The electronic device 101 may identify at least one first external electronic device matched to each of the IP addresses by grouping the log information based on the IP addresses. Based on identifying the first external electronic device, the electronic device 101 may obtain a second database that includes the IP address of the first external electronic device, and is grouped based on the IP addresses of the second external electronic devices 105. The electronic device 101 may obtain a third database including management information, based on user information indicating users matched to the IP addresses of the second database and the second external electronic devices 105.

According to an embodiment, the electronic device may identify the user information indicating the users matched to or associated with the IP addresses of the second external electronic devices 105 and grouped log information. In embodiments, the grouped log information may be referred to as the second database. For example, the user information indicating the users matched to the IP addresses of the second external electronic devices 105 may be associated with login information of the users using the second external electronic devices 105. For example, the login information of the users using the second external electronic devices 105 may include account information of each of the users who connected to each of the second external electronic devices 105. The electronic device 101 may obtain management information matched to at least one user corresponding to each of the first external electronic devices, based on the user information and the grouped log information. For example, the electronic device 101 may perform a join operation on the user information and the log information. The electronic device 101 may obtain the third database corresponding to the management information, based on the join operation. The management information may include user information of each of the second external electronic devices 105, an IP address of each of the second external electronic devices 105, and IP addresses of the first external electronic devices 103 to which each of the second external electronic devices 105 is connected. A description associated with the management information will be described later in FIG. 3C.

Referring to FIG. 1, according to an embodiment, the electronic device 101 may include at least one of a processor 120, the memory 130, or communication circuitry 140. The processor 120, the memory 130, and the communication circuitry 140 may be electronically and/or operably coupled with each other by an electrical component such as a communication bus 110. Hereinafter, hardware being operably coupled may mean that a direct or an indirect connection between the hardware is established by wire or wirelessly, so that second hardware among the hardware is controlled by first hardware. Although illustrated in different blocks, the embodiment is not limited thereto. A portion (e.g., at least a portion of the processor 120, the memory 130, and the communication circuitry 140) of the hardware of FIG. 1 may be included in a single integrated circuit, such as a system on a chip (SoC). A type and/or the number of the hardware included in the electronic device 101 is not limited as illustrated in FIG. 1. For example, the electronic device 101 may include only a portion of the hardware illustrated in FIG. 1.

According to an embodiment, the processor 120 of the electronic device 101 may include hardware for processing data based on one or more instructions. The hardware for processing the data may be referred to as the processor 120. The hardware for processing the data may include, for example, an arithmetic and logic unit (ALU), a floating point unit (FPU), a field programmable gate array (FPGA), a central processing unit (CPU), and/or an application processor (AP). The processor 120 may have a structure of a single-core processor, or may have a structure of a multi-core processor such as a dual core, a quad core, a hexa core, and an octa core.

According to an embodiment, the memory 130 of the electronic device 101 may include a hardware component for storing data and/or an instruction inputted and/or outputted by the processor 120 of the electronic device 101. For example, the memory 130 may include volatile memory such as a random-access memory (RAM) and/or non-volatile memory such as a read-only memory (ROM). For example, the volatile memory may include at least one of a dynamic RAM (DRAM), a static RAM (SRAM), a Cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SDD), and an embedded multi-media card (eMMC).

According to an embodiment, the electronic device 101 may manage information stored in the memory 130 based on a database (DB) 135 stored in the memory 130. In an embodiment, the database 135 may include at least one of a set of systematized information or one or more applications managing the information to be shared between independent applications executed in the electronic device 101 and/or a plurality of electronic devices including the electronic device 101. In the set of information, different information may be combined with each other based on a unit such as a type, a column, a record, and/or a table. The combination of information may be used for adding, deleting, updating, and searching information in the database 135. For example, in a state that the electronic device 101 searches for information of a preset condition, the electronic device 101 may further identify information that satisfies the condition and other information combined with the information using the database 135.

According to an embodiment, the communication circuitry 140 of the electronic device 101 may include the hardware component for supporting a transmission and/or a reception of an electrical signal between the electronic device 101 and the external electronic devices 103, 105, and 107. The first external electronic devices 103, the second external electronic devices 105, and the third external electronic devices 107 are illustrated as an electronic device connected to the electronic device 101 through the communication circuitry 140, but the embodiment is not limited thereto. For example, the communication circuitry 140 may include at least one of a modem, an antenna, and an optic/electronic (O/E) converter. The communication circuitry 140 may support the transmission and/or the reception of the electrical signal, based on various types of protocols such as an ethernet, a local area network (LAN), a wide area network (WAN), a wireless fidelity (WiFi), a bluetooth, a bluetooth low energy (BLE), a ZigBee, a long term evolution (LTE), and a 5th generation new radio (5G NR).

According to an embodiment, the electronic device 101 may receive log information including the IP addresses of the second external electronic devices accessing each of the plurality of first external electronic devices from a plurality of first external electronic devices 103 executing an agent program, by using the communication circuitry 140. For example, the log information may include binary information. The binary information may be information readable by an electronic device such as a computer. The electronic device 101 may obtain the second log information including the character string information based on receiving the log information that is the first log information including the binary information. For example, the electronic device 101 may change the first log information into the second log information. The electronic device 101 may generate (or obtain) a first database, based on changing the first log information into the second log information.

According to an embodiment, the electronic device 101 may group the first log information and/or the second log information obtained from the plurality of first external electronic devices 103, based on the IP addresses of the second external electronic devices 105. The electronic device 101 may identify the at least one first external electronic device matched to each of the IP addresses of the second external electronic devices 105 by grouping the second log information based on the IP addresses of the second external electronic devices 105. For example, the electronic device 101 may identify one of the first external electronic devices 103 accessed (or connected) by one of the second external electronic devices 105.

According to an embodiment, the electronic device 101 may identify the user information indicating the users matched to the IP addresses of the second external electronic devices 105, grouped first log information, and/or grouped second log information. User information indicating the users matched to the IP addresses of the second external electronic devices 105 may include a user identifier (ID), such as log-in information of the users managing each of the second external electronic devices 105. The electronic device 101 may obtain management information matched to at least one user corresponding to each of the plurality of first external electronic devices 103, based on the user information indicating the users matched to the IP addresses of the second external electronic devices 105 and the grouped log information (e.g., the second database). In the present disclosure, the management information may be referred to as the third database. For example, the management information may be obtained based on performing the join operation of the second database and the user information. According to an embodiment, the electronic device 101 may grant access authority to the second external electronic devices 105 for accessing the management information and/or the third database.

According to an embodiment, the electronic device 101 may receive issue information associated with the first external electronic devices 103 from the third external electronic devices 107. The electronic device 101 may tag the received issue information with data indicating the first external electronic devices 103 in the third database. The electronic device 101 may transmit a signal (or information) for notifying the tagging to an external electronic device matched to one of the second external electronic devices 103 based on the tagging.

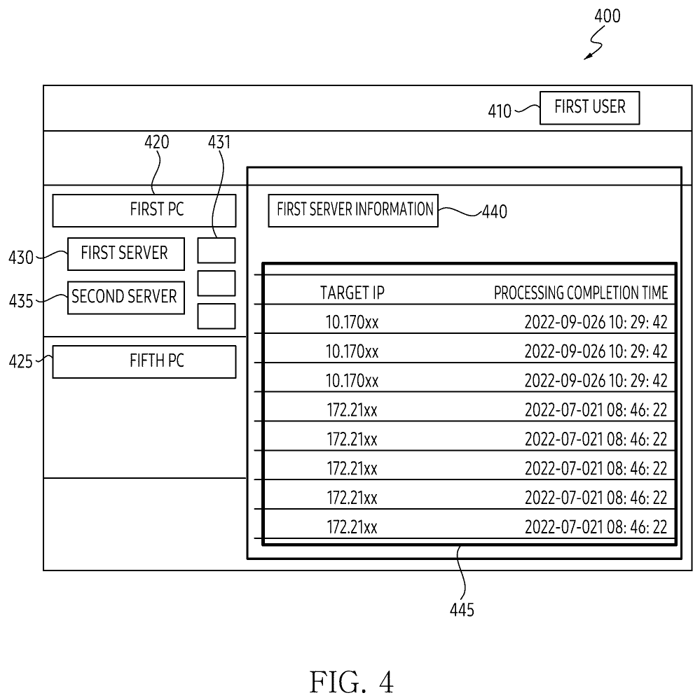

As described above, according to an embodiment, the electronic device 101 may obtain (or generate) a database (e.g., the third database), based on information (e.g., the log information and/or the user information) obtained from a plurality of external electronic devices 103 and 105. The electronic device 101 may receive issue information associated with the first external electronic devices 103 from the third external electronic devices 107. The electronic device 101 may tag the issue information with data indicating a first external electronic device associated with the issue information in the database. The electronic device 101 may grant access authority to the second external electronic devices 105 for accessing the database. Users may easily check the issue information using the second external electronic devices 105 to which the access authority is granted. An example for checking the issue information will be described later in FIG. 4.

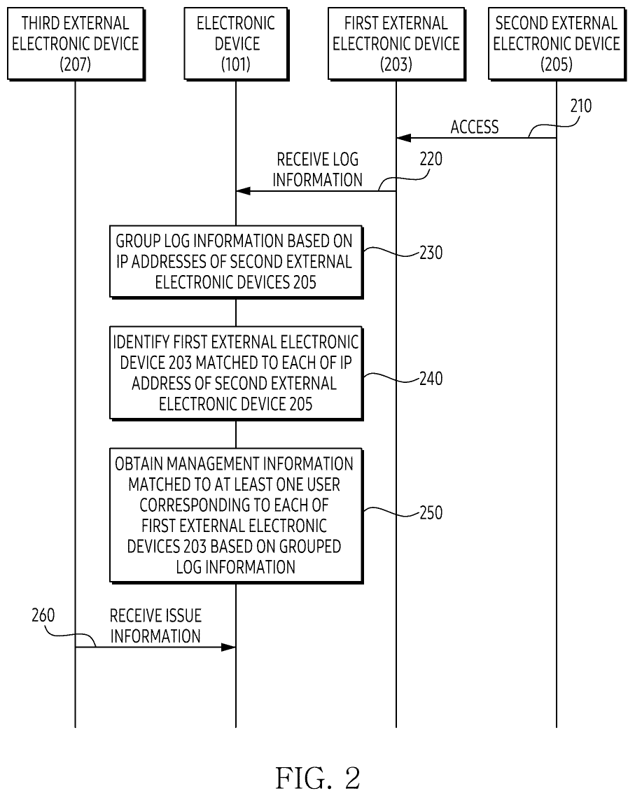

FIG. 2 illustrates an example of a signal flow chart associated with an operation of an electronic device according to an embodiment. An electronic device 101 of FIG. 2 may include the electronic device 101 of FIG. 1. Operations of FIG. 2 may be performed by the processor 120 of FIG. 1.

Referring to FIG. 2, in an operation 210, according to an embodiment, a second external electronic device 205 may access a first external electronic device 203. The first external electronic device 203 may be one of the first external electronic devices 103 of FIG. 1. The second external electronic device 205 may be one of the second external electronic devices 105 of FIG. 1. In an operation 220, according to an embodiment, the electronic device 101 may receive log information including information associated with access of the second external electronic device 205 from the first external electronic device 203, based on the access of the second external electronic device 205. The electronic device 101 may receive the log information including binary information. The electronic device 101 may obtain second log information including character string information, based on receiving first log information including the binary information. For example, the second log information may be a first database. For example, the first database may include a table, a column, and/or a row. For example, the first database may include columns indicating a type of data, and/or a row indicating information (or data) associated with the second external electronic device. In FIG. 2, the first external electronic device 203 and the second external electronic device 205 are illustrated as singular but may be plural.

In an operation 230, according to an embodiment, the electronic device 101 may group the log information, based on IP addresses of the second external electronic devices 205. The electronic device 101 may group the first database, based on the IP addresses of the second external electronic devices 205. For example, the electronic device 101 may group the log information or the first database, based on the IP address of the second external electronic device 205 that is an electronic device of a user. The electronic device 101 may obtain a second database based on the grouping. The second database may include an IP address of the user and a server IP address corresponding to the IP address of the user. An operation of grouping the log information (or the first database) based on the IP address of the second external electronic device 205 will be described later with in FIG. 3B.

In an operation 240, according to an embodiment, the electronic device 101 may identify the first external electronic device 203 matched to the IP address of the second external electronic device 205. The electronic device 101 may identify the first external electronic devices 203 matched to each of IP addresses of a plurality of second external electronic devices 205. For example, the electronic device 101 may identify IP addresses of the first external electronic devices 203.

In an operation 250, according to an embodiment, the electronic device may obtain management information matched to at least one user corresponding to each of the first external electronic devices 203, based on the grouped log information. For example, the electronic device 101 may obtain a third database that is the management information matched to the at least one user. The electronic device 101 may include information associated with the user of the second external electronic device 205, the IP address of the second external electronic devices 205, and the IP address of the first external electronic devices 203 in the management information. The electronic device 101 may group the second external electronic device 205 matched to the user of the second external electronic device 205. The description associated with the management information or the third database will be described later in FIG. 3C.

In an operation 260, according to an embodiment, the electronic device 101 may receive issue information from the third external electronic device 207. The issue information may be information associated with the first external electronic device 203. For example, the issue information may be associated with vulnerability of the first external electronic device 203 and/or an issue generated in the first external electronic device 203. For example, the vulnerability may include external electronic devices different from the first external electronic device 203 viewing an operation beyond permitted authority, or information beyond a permitted range. The electronic device 101 may tag the issue information to the management information or the third database, based on receiving the issue information.

As described above, according to an embodiment, the electronic device 101 may generate a database, based on information transmitted from the first external electronic device 203, the second external electronic device 205, and/or the third external electronic device 207. The electronic device 101 may provide a user interface (UI) for easily checking the issue to the user by generating the database. Thus enabling the user to check an issue in the first external electronic device 203 on the second external electronic device 205 based on information received from the third external electronic device 207.

FIG. 3A illustrates an example associated with log information received from a first external electronic device according to an embodiment. FIG. 3B illustrates an example of grouping log information and IP addresses of a second external electronic device according to an embodiment. FIG. 3C illustrates an example associated with management information according to an embodiment. An electronic device of FIGS. 3A to 3C may include the electronic device 101 of FIG. 1 and/or FIG. 2. Operations of FIGS. 3A to 3C may be performed by the processor 120 of FIG. 1.

Referring to FIG. 3A, according to an embodiment, an electronic device may receive log information 301 from a first external electronic device (e.g., the first external electronic devices 103 of FIG. 1 and/or the first external electronic device 203 of FIG. 2). The electronic device may receive the log information 301, based on a second external electronic device (e.g., the second external electronic devices 105 of FIG. 1 and/or the second external electronic device 205 of FIG. 2) accessing the first external electronic device. For example, the log information may include a type 303 and/or elements 305 corresponding to the type 303. The log information 301 may include an IP address of the first external electronic device. The log information 301 may include an operating system type of the first external electronic device. The operating system type may include system software for controlling hardware and/or a system resource and controlling a program. The log information 301 may include a time stamp. The time stamp may be a timing at which the log information is received. The log information 301 may include account information. The account information may include account information of a user logged in (or matched) to the second external electronic device used when accessing the first external electronic device. The log information 301 may include an IP address of the second external electronic device. The IP address of the second external electronic device may include a PC IP address of the user. The log information 301 may include a connection time. The connection time may include a time period in which the second external electronic device maintains access to the first external electronic device. The log information 301 may be referred to as a database.

Referring to FIG. 3B, according to an embodiment, the electronic device may identify the IP address of the second external electronic device, based on log information received from the first external electronic device and/or first external electronic devices. The electronic device may group the log information based on the IP address of the second external electronic device. The IP address of the second external electronic device may be referred to as the PC IP address. The IP address of the first external electronic device may be referred to as a server IP address. The electronic device may group the log information based on the IP address of the second external electronic device.

Referring to FIG. 3B, according to an embodiment, the electronic device may receive log information 311-1 to 311-10 from the first external electronic device. The electronic device may obtain a first database 311 based on receiving the log information 311-1 to 311-10. The electronic device may obtain a second database 311 including the IP addresses of second external electronic devices and the IP addresses of the first external electronic devices. For example, in the second database 311, the IP address of the second external electronic device may be an IP address identified when the second external electronic device accesses the first external electronic device. For example, the second external electronic device may be a terminal owned by the user. For example, the IP address of the first external electronic device may be an IP address of the first external electronic device accessing the second external electronic device. For example, the first external electronic device may be a server. The electronic device may group the second database 311 including IP addresses of a plurality of second external electronic devices, and IP addresses of the first external electronic devices accessing the second external electronic devices.

Hereinafter, the IP address of the second external electronic device may be described as the PC IP address. Hereinafter, the IP address of the first external electronic device may be referred to as the server IP address. The electronic device may receive first log information 311-1. The first log information 311-1 may include an IP address of a first PC and an IP address of a first server accessing the first PC. The electronic device may receive second log information 311-2. The second log information 311-2 may include an IP address of a second PC and an IP address of the first server accessing the second PC. The electronic device may receive third log information 311-3. The third log information 311-3 may include an IP address of a third PC and an IP address of a second server accessing the third PC. The electronic device may receive fourth log information 311-4. The fourth log information 311-4 may include the IP address of the first PC and an IP address of the second server accessing the first PC. The electronic device may receive fifth log information 311-5. The fifth log information 311-5 may include the IP address of the second PC and an IP address of a third server accessing the second PC. The electronic device may receive sixth log information 311-6. The sixth log information 311-6 may include an IP address of a fourth PC and an IP address of the third server accessing the fourth PC. The electronic device may receive seventh log information 311-7. The seventh log information 311-7 may include an IP address of a fifth PC and an IP address of a fourth server accessing the fifth PC. The electronic device may receive eighth log information 311-8. The eighth log information 311-8 may include the IP address of the third PC and an IP address of the fourth server accessing the third PC. The electronic device may receive ninth log information 311-9. The ninth log information 311-9 may include the IP address of the fifth PC and an IP address of the fifth server accessing the fifth PC. The electronic device may receive tenth log information 311-10. The tenth log information 311-10 may include the IP address of the fourth PC and an IP address of the fifth server accessing the fourth PC. The log information, IP addresses of the PCs, and/or IP addresses of the servers are only examples, but are not limited thereto.

According to an embodiment, the electronic device may group log information based on the IP addresses of the second external electronic devices. The electronic device may group the first log information 311-1 and the fourth log information 311-4 identified as the IP address of the first PC. The electronic device may obtain a portion of a second database 316 based on grouping the first log information 311-1 and the fourth log information 311-4. The electronic device may obtain a first portion 316-1 of the second database 316. The electronic device may identify the second log information 311-2 and the fifth log information 311-5 identified as the IP address of the second PC. The electronic device may group the second log information 311-2 and the fifth log information 311-5 identified as the IP address of the second PC. The electronic device may obtain a second portion 316-2 of the second database 316 based on grouping the second log information 311-2 and the fifth log information 311-5. The electronic device may identify the third log information 311-3 and the eighth log information 311-8 identified as the IP address of the third PC. The electronic device may group the third log information 311-3 and the eighth log information 311-8. The electronic device may obtain a third portion 316-3 of the second database 316 based on grouping the third log information 311-3 and the eighth log information 311-8. The electronic device may identify the sixth log information 311-6 and the tenth log information 311-10 identified as the IP address of the fourth PC. The electronic device may group the sixth log information 311-6 and the tenth log information 311-10 identified as the IP address of the fourth PC. The electronic device may obtain a fourth portion 316-4 of the second database 316 based on grouping the sixth log information 311-6 and the tenth log information 311-10. The electronic device may identify the seventh log information 311-7 and the ninth log information 311-9 identified as the IP address of the fifth PC. The electronic device may group the seventh log information 311-7 and the ninth log information 311-9 identified by as the IP address of the fifth PC. The electronic device may obtain a fifth portion 316-5 of the second database 316 based on grouping the seventh log information 311-7 and the ninth log information 311-9. The number of portions of the second database 316 is not limited to the above description.

Referring to FIG. 3C, according to an embodiment, the electronic device may obtain a third database 330 corresponding to the management information. The electronic device may identify user information 331-1 to 331-4 indicating users matched to the IP addresses of the second external electronic devices. The user information 331-1 to 331-4 may include information indicating the users of the second external electronic device. The user information 331-1 to 331-4 may include account information of a user logged in to the second external electronic device. The electronic device may obtain the management information based on the user information indicating the user and the second database. The second database may correspond to grouped log information.

The electronic device may identify first user information matched to the first portion 316-1 and the fifth portion 316-5 of the second database 316. The electronic device may identify the first user information, and the first PC and the fifth PC corresponding to the first user information. The electronic device may identify the IP address of the first PC and the IP address of the fifth PC. The first PC and the fifth PC corresponding to the first user information may be PCs used by a first user. The electronic device may obtain a first portion 331-1 of the third database 330 based on identifying the first PC and the fifth PC corresponding to the first user information. The electronic device may identify second user information matched to the second portion 316-2 of the second database 316. The electronic device may identify the second user information, and the second PC corresponding to the second user information. The electronic device may obtain a second portion 331-2 of the third database 316 based on identifying the second PC corresponding to the second user information. The electronic device may identify third user information matched to the third portion 316-3 of the second database 316. The electronic device may identify the third user information, and the third PC corresponding to the third user information. The electronic device may identify the IP address of the third PC. The electronic device may obtain a third portion 331-3 of the third database 330 based on identifying the third PC corresponding to the third user information. The electronic device may identify fourth user information matched to the fourth portion 316-4 of the second database 316. The electronic device may identify the fourth user information, and the fourth PC corresponding to the fourth user information. The electronic device may identify the IP address of the fourth PC. The electronic device may obtain a fourth portion 331-4 of the third database 330 based on identifying the fourth PC corresponding to the fourth user information. In FIGS. 3A to 3C, the electronic device may store obtained databases (e.g., the first database to the third database) in memory (e.g., the memory 130 of FIG. 1).

As described above, according to an embodiment, the electronic device may obtain log information including IP addresses of the second external electronic devices accessing each of the plurality of first external electronic devices, from the first external electronic devices, through communication circuitry (e.g., the communication circuitry 140 of FIG. 1). The electronic device may group the log information obtained from the plurality of first external electronic devices, based on the IP addresses of the second external electronic devices. The electronic device may identify at least one first external electronic device matched to each of the IP addresses by grouping the log information based on the IP addresses of the second external electronic devices. The electronic device may identify an IP address of the at least one first external electronic device matched to each of the IP addresses. The electronic device may obtain management information in which at least one user corresponding to each of the plurality of first external electronic devices is matched, based on user information indicating the users matched to the IP addresses and the grouped log information. The electronic device may store the management information in the memory based on obtaining the management information. The electronic device may transmit information associated with a screen for displaying the management information to the second external electronic device. By transmitting the information associated with the screen for displaying the management information to the second external electronic device, the users of the second external electronic device may check the management information through the screen.

FIG. 4 illustrates an example of a screen displayed based on management information, according to an embodiment. An electronic device of FIG. 4 may include the electronic device 101 of FIGS. 1 and/or 2, and the electronic device 101 of FIGS. 3A, 3B, and/or 3C. Operations of FIG. 4 may be performed by the processor 120 of FIG. 1.

Referring to FIG. 4, according to an embodiment, the electronic device may identify a second external electronic device (e.g., the external electronic devices 105 of FIG. 1 and/or the second external electronic device 205 of FIG. 2) different from a plurality of first external electronic devices (e.g., the first external electronic devices 103 of FIG. 1 and/or the first external electronic device 203 of FIG. 2) executing an agent program. The identification may be received using communication circuitry (e.g., the communication circuitry 140 of FIG. 1). The electronic device may identify a user logged in to the second external electronic device based on identifying the second external electronic device. The electronic device may identify the user logged in to the second external electronic device, based on identifying user account information logged in to the second external electronic device. According to an embodiment, the electronic device may identify management information stored in memory (e.g., the memory 130 of FIG. 1). For example, the management information may include the management information obtained in FIGS. 3A to 3C or a third database (e.g., the third database 330 of FIG. 3C).

According to an embodiment, the electronic device may transmit first information for displaying a screen 400 associated with IP addresses matched to a user 410 logged in to the second external electronic device to the second external electronic device, based on the management information. The IP addresses matched to the user 410 may include a visual object 420 indicating a first PC of FIG. 4 and/or a visual object 425 indicating a fifth PC.

For example, the electronic device may transmit the first information for displaying the screen 400 including a list of first external electronic devices matched to each of the IP addresses to the second external electronic device, based on the management information. For example, the electronic device may obtain the list from the plurality of first external electronic devices, based on log information including IP addresses of the second external electronic devices accessing each of the plurality of first external electronic devices. The electronic device may obtain, based on identifying at least one first external electronic device matched to each of the IP addresses, the list by grouping the log information based on the IP addresses of the second external electronic devices. The list of the first external electronic devices may include a visual object 430 indicating the first server of FIG. 4 and/or a visual object 435 indicating the second server of FIG. 4.

According to an embodiment, the electronic device may receive a signal indicating selection of a first external electronic device in the list from the second external electronic device. The signal indicating the selection of the first external electronic device may include a signal based on an input with respect to the visual object 430 indicating a first server and/or a visual object 431 for selecting the first server. The electronic device may transmit second information with respect to a first external electronic device selected in the list among the plurality of first external electronic devices to the second external electronic device, based on receiving the signal. The second information with respect to the first external electronic device may include a time at which the second external electronic device accessed the first external electronic device, and/or issue information transmitted from a third external electronic device (e.g., the third external electronic devices 107 of FIG. 1 and/or the third external electronic device 207 of FIG. 2). The electronic device may transmit the first information and/or the second information including the issue information to the second external electronic device. In FIG. 4, the issue information may be issue information 445. The electronic device may transmit the first information for displaying the issue information 445 to the second external electronic device in a screen displaying first server information 440.

According to an embodiment, the electronic device may transmit third information for displaying a visual object for notifying issue information to the second external electronic device, based on receiving the issue information from the third external electronic device. According to an embodiment, the electronic device may transmit the third information for outputting an audio signal for notifying the issue information to the second external electronic device, based on receiving the issue information. However, it is not limited thereto.

As described above, according to an embodiment, the electronic device may identify the second external electronic device different from the plurality of first external electronic devices executing the agent program. The electronic device may identify the user logged in to the second external electronic device, based on identifying the second external electronic device. The electronic device may transmit the first information for displaying the screen including the IP addresses matched to the user logged in to the second external electronic device, and the list of the first external electronic devices matched to each of the IP addresses to the second external electronic device, based on the management information. The electronic device may transmit the second information with respect to the first external electronic device selected in the list among the plurality of first external electronic devices to the second external electronic device to the second external electronic device, based on receiving the signal indicating the selection of the first external electronic device in the list from the second external electronic device. The electronic device may transmit the issue information in the first information and/or the second information, based on receiving the issue information from the third external electronic device. The electronic device may cause the user to recognize a problem occurring in the first external electronic device by transmitting the first information and the second information to the second external electronic device.

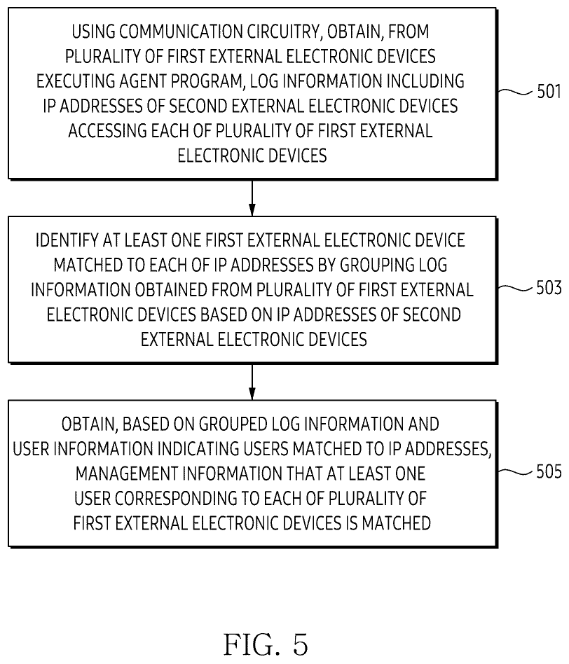

FIG. 5 illustrates an example of a flowchart with respect to an operation of an electronic device according to an embodiment. The electronic device of FIG. 5 may include the electronic device 101 of FIGS. 1 and/or 2, and the electronic device of FIGS. 3A, 3B, 3C, and/or 4. Operations of FIG. 5 may be performed by the processor 120 of FIG. 1.

Referring to FIG. 5, in an operation 501, according to an embodiment, the electronic device may obtain log information including IP addresses of second external electronic devices (e.g., the second external electronic devices 105 of FIG. 1 and/or the second external electronic device 205 of FIG. 2) accessing each of a plurality of first external electronic devices from the plurality of first external electronic devices (e.g., the first external electronic devices 103 of FIG. 1 and/or the first external electronic device 203 of FIG. 2) executing an agent program, using communication circuitry (e.g., the communication circuitry 140 of FIG. 1). The electronic device may obtain second log information, which is character string information, based on obtaining the first log information, which is binary information. The electronic device may obtain a first database based on the log information. The first database may be referred to as the first database 301 of FIG. 3A.

In an operation 503, according to an embodiment, the electronic device may group the log information obtained from the plurality of first external electronic devices based on the IP addresses of the second external electronic devices. The electronic device may group the log information based on the IP addresses of the second external electronic devices and identify at least one first external electronic device matched to each of the IP addresses. The electronic device may obtain a second database based on the grouped log information. The second database may be referred to as the second database 311 or 316 of FIG. 3B.

According to an embodiment, the electronic device may obtain IP addresses matched to a user logged in to the second external electronic device, and a list of first external electronic devices matched to each of the IP addresses. The electronic device may transmit first information for displaying a screen including the list to the second external electronic device.

In an operation 505, according to an embodiment, the electronic device may obtain, based on the grouped log information and user information indicating users matched to the IP addresses, management information that at least one user corresponding to each of the plurality of first external electronic devices is matched. The management information may be referred to as the third database 330 of FIG. 3C.

According to an embodiment, the electronic device may receive issue information from a third external electronic device. The issue information may include a problem occurring in the first external electronic device. The electronic device may identify one of a plurality of first external electronic devices associated with the issue information, based on receiving the issue information. The electronic device may tag the issue information to the management information, based on identifying one of the first external electronic devices associated with the issue information. The electronic device may transmit information for notifying the issue information to the second external electronic device.

As described above, according to an embodiment, the electronic device may obtain log information including IP addresses of the second external electronic devices accessing each of the plurality of first external electronic devices from a plurality of first external electronic devices executing an agent program. The electronic device may identify at least one first external electronic device matched to each of the IP addresses by grouping the log information obtained from the plurality of first external electronic devices, based on the IP addresses of the second external electronic devices. The electronic device may obtain, based on the grouped log information and user information indicating users matched to the IP addresses, management information that at least one user corresponding to each of the plurality of first external electronic devices is matched. The electronic device may receive issue information associated with the first external electronic device from the third external electronic device based on obtaining of the management information. The electronic device may tag the issue information to the management information based on identifying at least one of the first external electronic devices corresponding to the issue information. The electronic device may quickly identify a problem occurring in the first external electronic device by tagging the issue information to the management information.

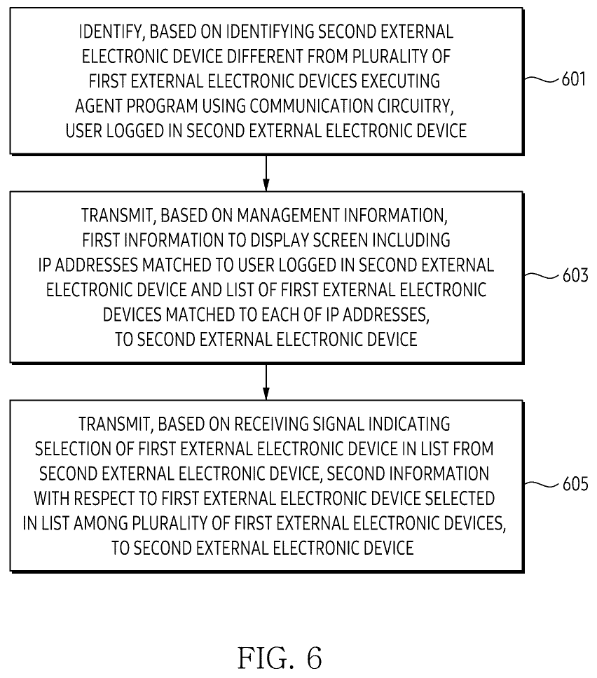

FIG. 6 illustrates an example of a flowchart with respect to an operation of an electronic device according to an embodiment. The electronic device of FIG. 6 may include the electronic device 101 of FIGS. 1 and/or 2, and the electronic device of FIGS. 3A, 3B, 3C, 4, and/or 5. Operations of FIG. 6 may be performed by the processor 120 of FIG. 1.

Referring to FIG. 6, in an operation 601, according to an embodiment, the electronic device may identify, using communication circuitry (e.g., the communication circuitry 140 of FIG. 1), a second external electronic device (e.g., the second external electronic device 205 of FIG. 2) different from a plurality of first external electronic devices (e.g., the first external electronic devices 103 of FIG. 1 and/or the first external electronic device 203 of FIG. 2) executing an agent program. The electronic device may identify a user logged in to the second external electronic device based on identifying the second external electronic device. The electronic device may identify the logged-in user by using user account information logged in to the second external electronic device.

In an operation 603, according to an embodiment, the electronic device may transmit first information for displaying a screen including IP addresses matched to the user logged in to the second external electronic device to the second external electronic device, based on management information. The electronic device may transmit the first information for displaying a screen including a list of first external electronic devices matched to each of the IP addresses matched to the user logged in to the second external electronic device to the second external electronic device, based on the management information.

The electronic device may obtain the list, based on receiving log information including IP addresses of second external electronic devices accessing the plurality of first external electronic devices from the first external electronic device. The electronic device may obtain, based on identifying at least one first external electronic device matched to each of the IP addresses, the list by grouping the log information based on the IP addresses of the second external electronic devices.

In an operation 605, according to an embodiment, the electronic device may receive a signal indicating selection of the first external electronic device in the list from the second external electronic device. The electronic device may transmit second information with respect to the first external electronic device selected in the list among the plurality of first external electronic devices to the second external electronic device, based on receiving the signal.

According to an embodiment, the electronic device may receive issue information from the third external electronic device. The electronic device may identify the first external electronic device associated with the issue information, based on receiving the issue information. The electronic device may transmit third information for notifying a problem occurring in the first external electronic device to the second external electronic device, based on identifying the first external electronic device associated with the issue information.

As described above, according to an embodiment, the electronic device may identify, based on identifying the second external electronic device different from the plurality of first external electronic devices executing the agent program using the communication circuitry, the user logged in the second external electronic device. The electronic device may transmit the first information to display the screen including the IP addresses matched to the user logged in the second external electronic device and a list of the first external electronic devices matched to each of the IP addresses, to the second external electronic device, based on the management information. The electronic device may transmit, based on receiving a signal indicating the selection of the first external electronic device in the list from the second external electronic device, the second information with respect to the first external electronic device selected in the list among the plurality of first external electronic devices, to the second external electronic device. The electronic device may transmit the third information for notifying the issue generated in the first external electronic device to the second external electronic device, based on receiving the issue information associated with the first external electronic device from the third external electronic device. The electronic device may assist the users of the second external electronic device to identify the issue generated in the first external electronic device, by transmitting the third information for notifying the issue generated in the first external electronic device to the second external electronic device.

As described above, according to an embodiment, the electronic device may comprise communication circuitry and a processor. The processor may be configured to, using the communication circuitry, obtain, from a plurality of first external electronic devices executing an agent program, log information including IP addresses of second external electronic devices accessing each of the plurality of first external electronic devices. The processor be configured to may identify at least one first external electronic device matched to each of the IP addresses by grouping the log information obtained from the plurality of first external electronic devices based on the IP addresses of the second external electronic devices. The processor may be configured to obtain, based on the grouped log information and user information indicating users matched to the IP addresses, management information that at least one user corresponding to each of the plurality of first external electronic devices is matched.

According to an embodiment, the processor may obtain, based on receiving the log information, a first database including the log information.

According to an embodiment, the processor may obtain, based on the log information and the IP addresses, a second database.

According to an embodiment, the processor may identify, based on identifying the second external electronic device using the communication circuitry, user account information logged in the second external electronic device.

According to an embodiment, the processor may transmit first information to display a screen including the IP addresses matched to the user logged in the second external electronic device, and a list of the first external electronic devices matched to each of the IP addresses, to the second external electronic device.

According to an embodiment, the processor may change first log information into second log information, which is character string information, based on receiving the log information, which is binary information and the first log information.

According to an embodiment, the processor may obtain, based on receiving issue information associated with the first external electronic device from a third external electronic device, management information including the issue information.

As described above, according to an embodiment, a method performed by an electronic device may comprise, using communication circuitry, obtaining, from a plurality of first external electronic devices executing an agent program, log information including IP addresses of second external electronic devices accessing each of the plurality of first external electronic devices. The method may comprise identifying at least one first external electronic device matched to each of the IP addresses by grouping the log information obtained from the plurality of first external electronic devices based on the IP addresses of the second external electronic devices. The method may comprise obtaining, based on the grouped log information and user information indicating users matched to the IP addresses, management information that at least one user corresponding to each of the plurality of first external electronic devices is matched.

According to an embodiment, the method may comprise obtaining, based on receiving the log information, a first database including the log information.

According to an embodiment, the method may comprise obtaining, based on the log information and the IP addresses, a second database.

According to an embodiment, the method may comprise identifying, based on identifying the second external electronic device using the communication circuitry, user account information logged in the second external electronic device.

According to an embodiment, the method may comprise transmitting first information to display a screen including IP addresses matched to the user logged in the second external electronic device, and a list of the first external electronic devices matched to each of the IP addresses, to the second external electronic device.

According to an embodiment, the method may comprise obtaining second log information, which is character string information, and first log information based on receiving the log information, which is binary information and the first log information.

According to an embodiment, the method may comprise obtaining, based on receiving issue information associated with the first external electronic device from a third external electronic device, management information including the issue information.

As described above, according to an embodiment, an electronic device may comprise memory, communication circuitry; and a processor. The processor may identify, based on identifying a second external electronic device different from a plurality of first external electronic devices executing an agent program using the communication circuitry, a user logged in the second external electronic device. The processor may transmit, based on management information, first information to display a screen including IP addresses matched to the user logged in to the second external electronic device and a list of the first external electronic devices matched to each of the IP addresses, to the second external electronic device. The processor may transmit, based on receiving a signal indicating selection of a first external electronic device in the list from the second external electronic device, second information with respect to the first external electronic device selected in the list among the plurality of first external electronic devices, to the second external electronic device.

According to an embodiment, the processor may obtain, based on log information in which the IP addresses of second external electronic devices accessing each of the plurality of first external electronic devices are included, the list.

According to an embodiment, the processor may obtain, based on identifying at least one first external electronic device matched to each of the IP addresses, the list by grouping the log information based on the IP addresses of the second external electronic devices.

According to an embodiment, the processor may obtain, based on user information indicating users matched to the IP addresses and the grouped log information, the management information to which at least one user corresponding to each of the plurality of first external electronic devices is matched.

According to an embodiment, the processor may receive, from a third external electronic device, issue information with respect to at least one of the plurality of first external electronic devices. According to an embodiment, the processor may transmit the first information including the issue information to the second external electronic device.

According to an embodiment, the processor may transmit, based on receiving the issue information, third information for notifying the issue information to the second external electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments of the present document may be implemented as software including one or more instructions that are stored in a storage medium (e.g., internal memory 136 or external memory 130) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry; and
one or more processors, wherein the one or more processors are configured to:
using the communication circuitry, obtain, from a plurality of first external electronic devices executing an agent program, log information associated with one or more second external electronic devices accessing each of the plurality of first external electronic devices, wherein the log information comprises first IP addresses associated with the plurality of first external electronic devices and second IP addresses associated with the one or more second external electronic devices;
determine a mapping of respective first external electronic devices with the one or more second external electronic devices that accessed the respective first external electronic devices based on a grouping of the log information obtained from the plurality of first external electronic devices based on the second IP addresses associated with the one or more second external electronic devices;
obtain, based on the grouping of the log information and user information indicating users associated with the second IP addresses, management information of at least one user associated with the respective first electronic devices;
identify an external electronic device different from the plurality of first external electronic devices; and
transmit, to the external electronic device, display information for displaying a user interface, the display information comprising issue information associated with a first external electronic device among the plurality of first external electronic devices and a visual object for notifying the issue information.

2. The electronic device of claim 1, wherein the one or more processors are further configured to:
obtain, based on the log information, a first database including the log information.

3. The electronic device of claim 1, wherein the one or more processors are further configured to:
obtain, based on the log information and the second IP addresses, a second database.

4. The electronic device of claim 1, wherein the one or more processors are further configured to:
identify, based on identifying the external electronic device, user account information logged in the external electronic device.

5. The electronic device of claim 4, wherein the display information comprises first information to display a screen including the second IP addresses associated with the user account information logged in the external electronic device, and a list of the respective first external electronic devices associated with each of the second IP addresses comprised in the first information.

6. The electronic device of claim 1, wherein the log information is first log information and comprises binary information, and wherein the one or more processors are configured to:
change, based on the first log information, the first log information to second log information, the second log information comprising character string information.

7. The electronic device of claim 1, wherein the one or more processors are configured to:
obtain, based on the issue information associated with the first external electronic device being received from a third external electronic device, the management information.

8. A method for presenting user information and issue information in a network comprising a plurality of devices, the method being performed by one or more processors of an electronic device, the method comprising:
using communication circuitry, obtaining, from a plurality of first external electronic devices executing an agent program, log information associated with one or more second external electronic devices accessing each of the plurality of first external electronic devices, wherein the log information comprises first IP addresses associated with the plurality of first external electronic devices and second IP addresses associated with the one or more second external electronic devices;
determining a mapping of respective first external electronic devices with the one or more second external electronic devices that accessed the respective first external electronic devices based on a grouping of the log information obtained from the plurality of first external electronic devices based on the second IP addresses associated with the one or more second external electronic devices;
obtaining, based on the grouping of the log information and user information indicating users associated with the second IP addresses, management information of at least one user associated with the respective first electronic devices;
identifying an external electronic device different from the plurality of first external electronic devices; and
transmitting, to the external electronic device, display information for displaying a user interface, the display information comprising issue information associated with a first external electronic device among the plurality of first external electronic devices and a visual object for notifying the issue information.

9. The method of claim 8, further comprising:
obtaining, based on the log information, a first database including the log information.

10. The method of claim 8, further comprising:
obtaining, based on the log information and the second IP addresses, a second database.

11. The method of claim 8, further comprising:
identifying, based on identifying the external electronic device, user account information logged in the external electronic device.

12. The method of claim 11, wherein the display information comprises first information to display a screen including the second IP addresses associated with the user account information logged in the external electronic device, and a list of the respective first external electronic devices associated with each of the second IP addresses comprised in the first information.

13. The method of claim 8, wherein the log information is first log information and comprises binary information, and the method further comprises:
changing, based on the first log information, the first log information to second log information, the second log information comprising character string information.

14. The method of claim 8, further comprising:
obtaining, based on the issue information associated with the first external electronic device being received from a third external electronic device, the management information.

15. An electronic device comprising:
memory;
communication circuitry; and
one or more processors, the one or more processors are configured to:
identify, based on identifying an external electronic device different from a plurality of first external electronic devices executing an agent program using the communication circuitry, a user logged in the external electronic device;
transmit, based on management information, first information to display a screen including IP addresses associated with the user logged in the external electronic device and a list of the one or more first external electronic devices associated with each of the IP addresses, to the external electronic device; and
transmit, based on receiving a signal indicating selection of a first external electronic device in the list of the one or more first external electronic devices from the external electronic device, second information with respect to the first external electronic device selected in the list, to the external electronic device.

16. The electronic device of claim 15, wherein the one or more processors are configured to:
obtain, based on log information in which the IP addresses of second external electronic devices accessing each of the plurality of first external electronic devices are included, the list.

17. The electronic device of claim 16, wherein the one or more processors are configured to:
obtain, based on identifying at least one first external electronic device associated with each of the IP addresses, the list by grouping the log information based on the IP addresses of the second external electronic devices.

18. The electronic device of claim 17, wherein the one or more processors are configured to:
obtain, based on user information indicating users associated with the IP addresses and the grouping of the log information, the management information in which at least one user corresponding to each of the plurality of first external electronic devices is identified.

19. The electronic device of claim 15, wherein the one or more processors are configured to:
receive, from a third external electronic device, issue information with respect to at least one of the plurality of first external electronic devices; and
transmit the first information including the issue information to the external electronic device.

20. The electronic device of claim 19, wherein the one or more processors are configured to:
transmit, based on receiving the issue information, third information for notifying the issue information to the external electronic device.
